(19) United States
(12) Patent Application Publication
(10) Pub. No.: US 2025/0117125 A1
(43) Pub. Date: Apr. 10, 2025

(54) AUTOMATED IMAGE ORGANIZATION SYSTEM

(71) Applicant: Airbnb, Inc., San Francisco, CA (US)

(72) Inventors: Dana Leigh Ingraham, Orinda, CA (US); McLane Teitel, Lynbrook, NY (US); Sevilla Garza Weaver, San Antonio, TX (US); Mark Dennis Laughlin, JR., Santa Cruz, CA (US); Guillaume Golsong, Mill Valley, CA (US); Dean Zhuiyang Chen, Henderson, NV (US); Julian Ozen, Brooklyn, NY (US); Usman Abbasi, Menlo Park, CA (US)

(21) Appl. No.: 18/905,551

(22) Filed: Oct. 3, 2024

Related U.S. Application Data
(60) Provisional application No. 63/543,341, filed on Oct. 10, 2023.

(51) Int. Cl. G06F 3/04845; G06F 16/55; G06F 16/9536; G06Q 10/02

(52) U.S. Cl. CPC G06F 3/04845; G06F 16/55; G06F 16/9536; G06Q 10/02

(57) ABSTRACT

Methods and systems that organize images for accommodation listings are described. The methods and systems present, in a graphical user interface (GUI), an option to arrange the plurality of images according to classifications associated with the plurality of images. The methods and systems, in response to receiving input that selects the option, animate in the GUI a subset of the plurality of images as being shuffled into one or more of the classifications and, after the subset of the plurality of images are animated for a specified threshold period of time, present in the GUI a template comprising a plurality of regions each associated with a different classification. The methods and systems populate regions of the plurality of regions associated with different classifications with respective images that correspond to the classifications.

### CROSS-REFERENCE TO RELATED APPLICATION

This is a non-provisional application of and claims priority to U.S. Provisional App. No. 63/543,341, filed Oct. 10, 2023, which is hereby incorporated by reference in its entirety.

### TECHNICAL FIELD

The present disclosure generally relates to special-purpose machines that manage data processing and improvements to such variants, and to the technologies by which such special-purpose machines become improved compared to other special-purpose machines for generating listings for reservations on a property listings site.

### BACKGROUND

Network site users can create content for viewing and interaction by other network site users (e.g., booking, registering, subscribing, viewing of listings). The posted content can be updated, created, or deleted, and it can be computationally challenging for a network site to return valid search results to network site users searching for content (e.g., listings for reservations) with specified parameters (e.g., dates, categories, prices, quantity). For example, if there are a large number of users posting and updating content and also a large number of users submitting complex searches for the posted content, any delay in computation due to query complexity may cause inaccurate results to be returned and cause large computational resource consumption (e.g., processing, memory, network overhead).

### BRIEF DESCRIPTION OF THE DRAWINGS

Various ones of the appended drawings merely illustrate example embodiments of the present disclosure and should not be considered as limiting its scope.

FIG. 1 is a block diagram illustrating a search and display system implemented in a networked environment, according to some examples.

FIG. 2 shows an example of functional engines of a search and display system, according to some examples.

FIG. 3 shows a listings network site user interface generated by the listing network platform and search and display system (or listing search system), according to some examples.

FIGS. 4-7 show example configurations and user interfaces of a listing search system, according to some examples.

FIG. 8 shows a flow diagram of various processes and methods for generating listings for the listing network site, according to some examples.

FIG. 9 is a block diagram illustrating the architecture of software used to implement the disclosed system, according to some examples.

FIG. 10 shows a machine as an example computer system with instructions to cause the machine to implement the disclosed system, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various embodiments of the inventive subject matter. It will be evident, however, to those skilled in the art, that examples of the inventive subject matter may be practiced without these specific details. In general, well-known instruction instances, protocols, structures, and techniques are not necessarily shown in detail.

As discussed above, it can be difficult to return up-to-date results for complex queries for content posted on a network site. In addition, navigating the vast array of content available on the network site can be very complex and time consuming. Such navigation can entail browsing multiple pages of information to find a suitable result or action. To this end, a search and display system can be configured to efficiently search for complex queries, allow browsing of a network site, and return accurate results and perform requested actions with low computational resource usage. Although in the following discussion the example posted content are accommodations listings (e.g., listings for reservations) posted on a network site for searching and interacting with other end users, other types of network site content posted by end users and searched for by other end users can likewise be implemented in the search and display system processes and methods, such as transportation, experiences, and/or events.

Generally, a listing platform can be searched for result listings that are available for a specified date range, price range, and/or other attributes, such as amenities, cancelation policy, and the like, which can be specified in a given query (e.g., text field, drop-down menu, checkbox filters). To search and browse the listing platform, users can access the listing platform on a particular user interface channel, such as by phone or through an application associated with the listing platform.

Sometimes, these systems present users with results that include various images of different aspects of the corresponding listings. The images can be grouped or arranged in random order or in no particular sequence at all. In either case, trying to ascertain which part of the physical accommodation is represented by a particular image can be challenging. For example, an image can include a depiction of a bed and the listing can include multiple bedrooms. Such an image provides little information as to which bedroom is represented by image, which causes the user to be confused. The user may need to navigate back and forth through multiple images to try to determine which bedroom is represented by a particular image. This repetitive and manual process is incredibly time consuming and can be very frustrating to end users. This can result in missed opportunities and wasted computational resources.

To address these technical problems, the disclosed techniques provide a network site that classifies (categorizes) images for a particular listing automatically or semi-automatically in an efficient manner. Namely, the network site presents, in a graphical user interface (GUI), an option to arrange the plurality of images according to classifications associated with the plurality of images. The network site, in response to receiving input that selects the option, animates in the GUI a subset of the plurality of images as being shuffled into one or more of the classifications. After, before, and/or during animation of the subset of the plurality of images for a specified threshold period of time, the network site presents in the GUI a template that includes a plurality of regions, each associated with a different classification, and populates regions of the plurality of regions associated with different classifications with respective images that correspond to the classifications.

Classification of images in this way can help the user easily identify and select listings that may be of interest by accessing a GUI that presents images associated with the listings according to classifications associated with the images. In this way, the network site can prevent having to execute additional search queries or refining an initial search query and having a user navigate back and forth through multiple pages of information. This, in effect, reduces the amount of computational resources needed to be dedicated and consumed by a given searching end-user which frees up such resources for other tasks and satisfying other search requests.

In some aspects, the techniques described herein relate to a method including: receiving, by a network site of a listing network platform, input including a plurality of images associated with an individual listing; presenting, in a GUI, an option to arrange the plurality of images according to classifications associated with the plurality of images; in response to receiving input that selects the option, animating in the GUI a subset of the plurality of images as being shuffled into one or more of the classifications; after the subset of the plurality of images are animated for a specified threshold period of time, presenting in the GUI a template including a plurality of regions, each associated with a different classification; and populating a first region of the plurality of regions associated with a first classification with a first image that corresponds to the first classification and a second region of the plurality of regions associated with a second classification with a second image that corresponds to the second classification.

In some aspects, the techniques described herein relate to a method, further including: analyzing the plurality of images by a machine learning model to determine respective classifications associated with each of the plurality of images.

In some aspects, the techniques described herein relate to a method, wherein the machine learning model analyzes the plurality of images in response to receiving the input that selects the option to arrange the plurality of images according to classifications associated with the plurality of images. The machine learning model can include multiple machine learning models. A first machine learning model can be used to assign classification scores to individual images indicating likelihoods that the images correspond to certain classifications. A second machine learning model can be applied to the images to cluster the images based on similarity. This can be used when multiple of the same classifications (e.g., multiple bedrooms) are associated with a particular listing. The second machine learning model can generate embeddings for the images and can cluster images with similar embeddings with the same bedrooms, so that a first group of images is clustered and associated with a first bedroom and a second group of images is clustered and associated with a second bedroom.

In some aspects, the techniques described herein relate to a method, wherein the machine learning model analyzes the plurality of images as each respective image of the plurality of images is received by the input and prior to presenting the option to arrange the plurality of images in the GUI.

In some aspects, the techniques described herein relate to a method, further including: receiving additional input including an additional image associated with the listing; and in response to receiving the additional input, re-analyzing the plurality of images that have previously been classified by the machine learning model together with the additional image to generate or update classifications for each of the plurality of images including the additional image.

In some aspects, the techniques described herein relate to a method, wherein the first classification includes a first room type, and wherein the second classification includes a second room type.

In some aspects, the techniques described herein relate to a method, further including: enabling a user to modify the classifications associated with the plurality of images by interacting with the template presented in the GUI.

In some aspects, the techniques described herein relate to a method, wherein an ordering in which the plurality of regions are presented in the GUI is predefined, the ordering including a living area, full kitchen, kitchenette, dining area, bedroom, full bathroom, half bathroom, office, dedicated workspace, backyard, patio, balcony, front yard, deck, porch, courtyard, garden, terrace, rooftop, laundry area, garage, gym, exterior, pool, hot tub, theme room, children's playroom, bowling alley, movie theater, art studio, music studio, workshop, photography studio, darkroom, wood shop, event space, library, game room, sunroom, and wine cellar.

In some aspects, the techniques described herein relate to a method, further including: selecting one or more images from the plurality of images based on one or more criteria; and presenting the one or more images that have been selected in a graphical element including the option to arrange the plurality of images according to classifications.

In some aspects, the techniques described herein relate to a method, wherein the one or more criteria includes at least one of an order in which the images are presented in the listing or respective classifications of the images.

In some aspects, the techniques described herein relate to a method, wherein the subset of the plurality of images includes the one or more images that have been selected, further including: presenting a graphical element that presents the animating of the subset of the plurality of images on top of the template, wherein each of the plurality of regions of the template includes a placeholder for respective images.

In some aspects, the techniques described herein relate to a method, wherein the placeholder includes a gray box.

In some aspects, the techniques described herein relate to a method, further including: presenting an animation including celebration graphics on top of the template that includes the first region with the first image and the second region with the second image.

In some aspects, the techniques described herein relate to a method, wherein the celebration graphics include at least one of confetti, balloons, or a logo associated with the network site.

In some aspects, the techniques described herein relate to a method, further including: determining that an individual classification of the plurality of classifications is unassigned to any of the plurality of images; identifying an individual region of the plurality of regions associated with the individual classification; and populating the individual region in the GUI with a three-dimensional (3D) graphical element that represents the individual classification in response to determining that the individual classification is unassigned to any of the plurality of images.

In some aspects, the techniques described herein relate to a method, further including: storing a database that associates a plurality of classifications with respective 3D graphical elements representing the classifications; and retrieving, from the database, the 3D graphical element by searching the database based on the individual classification.

In some aspects, the techniques described herein relate to a method, further including: obtaining a list of amenities associated with the individual listing; detecting a physical space in an individual image of the plurality of images; selecting an individual classification of the plurality of classifications based on the list of amenities associated with the individual listing and the detected physical space; and associating the individual classification with the individual image.

In some aspects, the techniques described herein relate to a method, further including: determining that the list of amenities includes a first amenity and excludes a second amenity; and in response to determining that the list of amenities includes the first amenity and excludes the second amenity, selecting a first classification as the individual classification; and in response to determining that the list of amenities excludes the first amenity and excludes the second amenity, selecting a second classification as the individual classification.

In some aspects, the techniques described herein relate to a system including: one or more processors of a machine; and a memory storing instruction that, when executed by the one or more processors, cause the machine to perform operations including: receiving, by a network site of a listing network platform, input including a plurality of images associated with an individual listing; presenting, in a GUI, an option to arrange the plurality of images according to classifications associated with the plurality of images; in response to receiving input that selects the option, animating in the GUI a subset of the plurality of images as being shuffled into one or more of the classifications; after the subset of the plurality of images are animated for a specified threshold period of time, presenting in the GUI a template including a plurality of regions each associated with a different classification; and populating a first region of the plurality of regions associated with a first classification with a first image that corresponds to the first classification and a second region of the plurality of regions associated with a second classification with a second image that corresponds to the second classification.

In some aspects, the techniques described herein relate to a machine-readable storage device embodying instructions that, when executed by a machine, cause the machine to perform operations including: receiving, by a network site of a listing network platform, input including a plurality of images associated with an individual listing; presenting, in GUI, an option to arrange the plurality of images according to classifications associated with the plurality of images; in response to receiving input that selects the option, animating in the GUI a subset of the plurality of images as being shuffled into one or more of the classifications; after the subset of the plurality of images are animated for a specified threshold period of time, presenting in the GUI a template including a plurality of regions each associated with a different classification; and populating a first region of the plurality of regions associated with a first classification with a first image that corresponds to the first classification and a second region of the plurality of regions associated with a second classification with a second image that corresponds to the second classification.

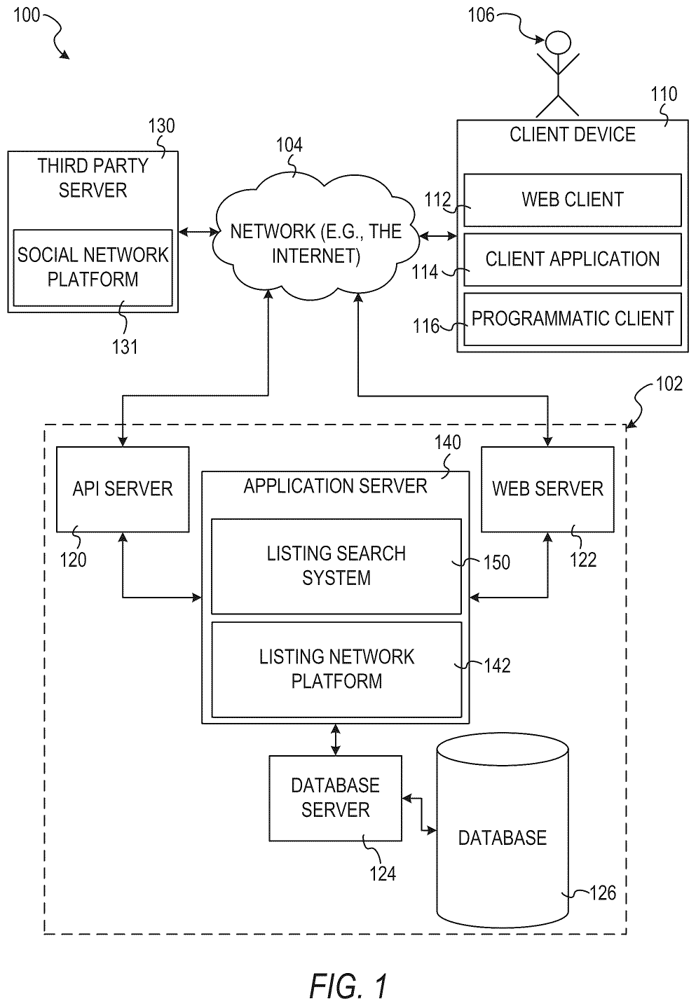

With reference to FIG. 1, an example of a high-level client-server-based network architecture 100 is shown. A networked system 102, in the example form of a network-based listing services system, provides server-side functionality via a network 104 (e.g., the Internet or wide area network (WAN)) to one or more client devices 110. In some implementations, a user (e.g., user 106) interacts with the networked system 102 using the client device 110.

FIG. 1 illustrates, for example, a web client 112 (e.g., a browser), a client application(s) 114, and a programmatic client 116 executing on the client device 110. The client device 110 includes the web client 112, the client application(s) 114, and/or the programmatic client 116 alone, together, or in any suitable combination. Although FIG. 1 shows one client device 110, in other implementations, the network architecture 100 comprises multiple client devices.

In various implementations, the client device 110 can include a computing device that includes at least a display and communication capabilities that provide access to the networked system 102 via the network 104. The client device 110 includes, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box (STB), network personal computer (PC), mini-computer, and so forth. In an example, the client device 110 includes one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof.

In some examples, the client device 110 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and reservation applications for temporary stays or experiences at hotels, motels, or residences managed by other end users (e.g., a posting end user who owns a home and rents out the entire home or private room, which is referred to as a “host”).

In some implementations, the client application(s) 114 include various components operable to present information to the user and communicate with the networked system 102. In some examples, if the e-commerce site application is included in the client device 110, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the e-commerce site application is not included in the client device 110, the client device 110 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via the programmatic interface provided by an Application Program Interface (API) server 120.

Users (e.g., the user 106) can include a person, a machine, or other means of interacting with the client device 110. In some examples, the user 106 is not part of the network architecture 100, but interacts with the network architecture 100 via the client device 110 or another means. For instance, the user 106 provides input (e.g., touch screen input or alphanumeric input) to the client device 110 and the input is communicated to the networked system 102 via the network 104 by way of the second user interaction channel. In this instance, the networked system 102, in response to receiving the input from the user 106, communicates information to the client device 110 via the network 104 to be presented to the user 106. In this way, the user 106 can interact with the networked system 102 using the client device 110. As another example, the user 106 provides input (e.g., speech input) to the client device 110 and the input is communicated to the networked system 102 via the network 104 in the form of audio packets or audio data.

The API server 120 and the web server 122 are coupled to, and provide programmatic and web interfaces respectively to, one or more application server(s) 140. The application server(s) 140 may host a listing network platform 142 and a listing search system 150, each of which includes one or more modules or applications and each of which can be embodied as hardware, software, firmware, or any combination thereof. The application server(s) 140 are, in turn, shown to be coupled to one or more database server(s) 124 that facilitate access to one or more information storage repositories or database(s) 126. In an example, the database(s) 126 are storage devices that store information to be posted (e.g., inventory, image data, catalog data, 3D and/or 2D representations of room/space classifications) to the listing network platform 142. The database(s) 126 also store digital goods information in accordance with some examples.

Additionally, a social network platform 131 is illustrated as executing on third-party server(s) 130. Further, the social network platform 131 can programmatically access the networked system 102 via the programmatic interface provided by the API server 120. The social network platform 131 may include a social network website, messaging platform, and one or more APIs. In some examples, the electronic message discussed below is a message sent to a given user via the social network platform 131 messaging system (e.g., social media chat message, post, ping (a “hello” notification), and so on).

The listing network platform 142 provides a number of publication functions and listing services to the users who access the networked system 102. While the listing network platform 142 is shown in FIG. 1 to form part of the networked system 102, it will be appreciated that, in alternative examples, the listing network platform 142 may form part of a web service that is separate and distinct from the networked system 102.

While the client-server-based network architecture 100 shown in FIG. 1 employs a client-server architecture, the disclosed techniques are not limited to such an architecture, and can equally be implemented in a distributed, or peer-to-peer, architecture system, for example. The various systems of the applications server(s) 140 (e.g., the listing network platform 142 and listing search system 150) may also be implemented as standalone software programs, which do not necessarily have networking capabilities.

The listing network platform 142 can be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124. The listing network platform 142 provides a number of publishing and listing mechanisms whereby a seller (also referred to as a “first user,” posting user, host) may list (or publish information concerning) goods or services for sale or barter; a buyer (also referred to as a “second user,” searching user, guest) can express interest in or indicate a desire to purchase or barter such goods or services; and a transaction (such as a trade) may be completed pertaining to the goods or services.

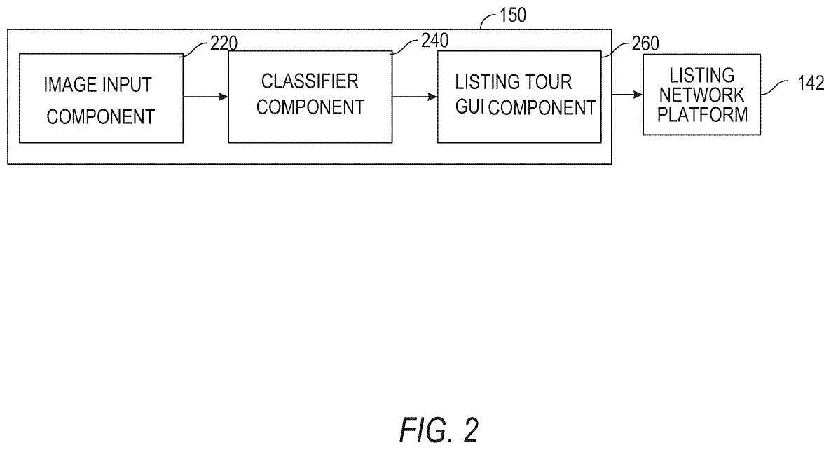

FIG. 2 shows example functional engines of the listing search system 150, according to some examples. As illustrated, the listing search system 150 includes an image input component 220, a classifier component 240, and a listing tour GUI component 260. In some examples, a user may desire to perform some action with the listing network platform 142. For example, the user, such as a host of an accommodation, may desire to generate a listing for reservation, modify one or more listings for reservations held by the listing network platform 142, and/or to perform any other available function on the listing network platform 142.

In some examples, the GUI allows a user to access listings for reservations associated with the user, for example in the case where the user is a host (e.g., owner, manager) of the listing. The GUI receives input from the user that selects an individual listing. In response, the GUI presents various information about the listing, including one or more images, amenities, dates of availability, description information, location information, and/or price or booking details. The GUI can receive input from the user requesting to modify, edit, or adjust any of the information about the listing that is presented. Once the information is modified and, optionally, approved by a moderator, the listing is updated and made available to other users of the network site who are searching for accommodations.

In some examples, the GUI allows the user to improve the look and functioning of the listing, such as by automatically assigning images to respective classifications. For example, the network site assigns a classification for each of the images in the listing and then categorizes the images by space type, based on the classification. Namely, a first machine learning model generates and associates classifications for images. A second machine learning model generates embeddings for the images to cluster similar images together and associate such similar images with the same classification (e.g., room type).

The network site generates a tour GUI that includes the images organized according to space type (also referred to as a classification or category). The tour GUI presents one or more images for one or more of the plurality of classifications. This allows the host and one or more end users (e.g., guests) to quickly and easily determine what is being shown and represented by different images. An individual classification can be selected by input from the GUI to cause a subset of images associated with the individual classification to be presented in a new GUI.

To assign a classification to each image, the image input component 220 processes the images as they are input to generate and assign classifications or categories to the images. Namely, a collection or plurality of images can initially be received from the user and associated with the particular listing. The plurality of images is provided to the classifier component 240 to generate classifications to the images. This operation can be performed before receiving input from a host to generate a photo tour in order to reduce processing times and resources needed to perform such classifications on the fly in real time.

In one example, the classifier component 240 generates a prediction score indicating how likely the image is associated with a specific room type. A room type is selected for the image based on a threshold prediction score. For example, if an image has a 0.8 prediction score that it is associated with a bedroom and a 0.4 prediction score that it is associated with a living room, the bedroom room type would be selected by the system for the image. The classifier component 240 implements one or more machine learning models (e.g., artificial neural networks and/or convolutional neural networks) that are trained to analyze features of a collection of images to predict classifications for each of the images. The classifier component 240 can include a second machine learning model to cluster images based on embeddings, as discussed below.

Specifically, the classifier component 240 can be trained by processing training data that includes different groups of images and respective ground truth classifications of the images. The classifier component 240 can access an individual group of images and extracts features from the group of images. The classifier component 240 predicts or estimates respective classifications of the images in the group of images based on the extracted features. Each image can be assigned to only one classification. The classifier component 240 can then obtain the ground truth classifications associated with the group of images. The classifier component 240 can compare the classification associated with each image in the group of images that has been estimated with the corresponding ground truth classification. The classifier component 240 can compute a deviation based on the comparison and can then update parameters of the classifier component 240 based on the deviation. The classifier component 240 can repeat this training process for additional groups of images until a stopping criterion is reached.

In some examples, the image input component 220 receives input that adds a new or additional image in association with the listing for which a prior collection of images has already been classified. In response, the image input component 220 provides the new image to the classifier component 240 with an instruction to classify the new image. The classifier component 240 obtains the previously classified images along with their classifications. The classifier component 240 then re-analyzes all of the images including those that have already been classified together with the new image. The classifier component 240 generates or estimates a new classification for the new image and can update one or more classifications associated with the previously classified images. In some cases, only the new image is classified independently of the other images but a second machine learning model is applied collectively to all the images and their classifications in order to group or cluster similar images together based on their generated embeddings.

For example, the classifier component 240 determines that a first image in the collection of images that have previously been classified was associated with a first classification (e.g., a first bedroom classification). The classifier component 240 processes the new image together with the first image to derive new information about the first image and the new image. Particularly, the new image can also represent a bedroom that includes similar features as the first image. In such cases, the classifier component 240 determines that the first image and the new image belong to the same classification. In addition, the classifier component 240 can determine that the new image corresponds to a second classification (e.g., a second bedroom classification). In such cases, the classifier component 240 updates the classification associated with the first image from being the first classification to being the second classification in response to processing the new image (which has not yet been classified) together with previously classified images.

In some examples, the classifier component 240 generates a prediction score for each image classification indicating a likelihood that the image belongs to a specific classification or room. The classifier component 240 obtains all the images and their respective scores and determines whether for each classification the score of the respective image transgresses a threshold. The classifier component 240 assigns the classification to the image having the score of the classification that transgresses the threshold. For example, if an image has a first score for a first classification and a second score for a second classification, the classifier component 240 compares the first score to a first threshold and the second score to a second threshold. If the first score fails to transgress the threshold but the second score does transgress the threshold, the classifier component 240 assigns the image to the second classification instead of the first classification.

After obtaining or generating classifications and/or scores for each of the images, the classifier component 240 processes the classified images with an additional machine learning model (e.g., an additional artificial neural network). The additional machine learning model generates embeddings for each image (before and/or after the images are classified by a first machine learning model). The embeddings are compared for each of the images to each other in order to cluster and/or group images having similar embeddings together. For example, the classifier component 240 obtains embeddings generated for a first image and embeddings generated for a second image and each additional image. The classifier component 240 computes a similarity score (e.g., by computing a cosine similarity) between the first image embeddings and the embeddings of each additional image including the second image embedding. The classifier component 240 determines that the embedding of the first image is similar to the embedding of the second image by more than a specified threshold. In such cases, the classifier component 240 groups the first image with the second image to generate a first cluster of images. Similar operations are performed to cluster all of the other images.

The classifier component 240 provides the images that have been classified to the listing tour GUI component 260. The listing tour GUI component 260 presents a GUI that allows a user to request automated classification of images associated with the listing. In some cases, the classifier component 240 performs the classification in response to input received from the GUI requesting that the classification be performed. In some cases, the classifier component 240 performs the classification before the GUI presents an option for the user to request the classification to be performed. After the images are classified, the classifications of the images are presented to end users on the listing network platform 142 in an organized manner or GUI. For example, a GUI can be presented where different regions of the GUI correspond to different classifications and a single representative image is presented in each region, as discussed below.

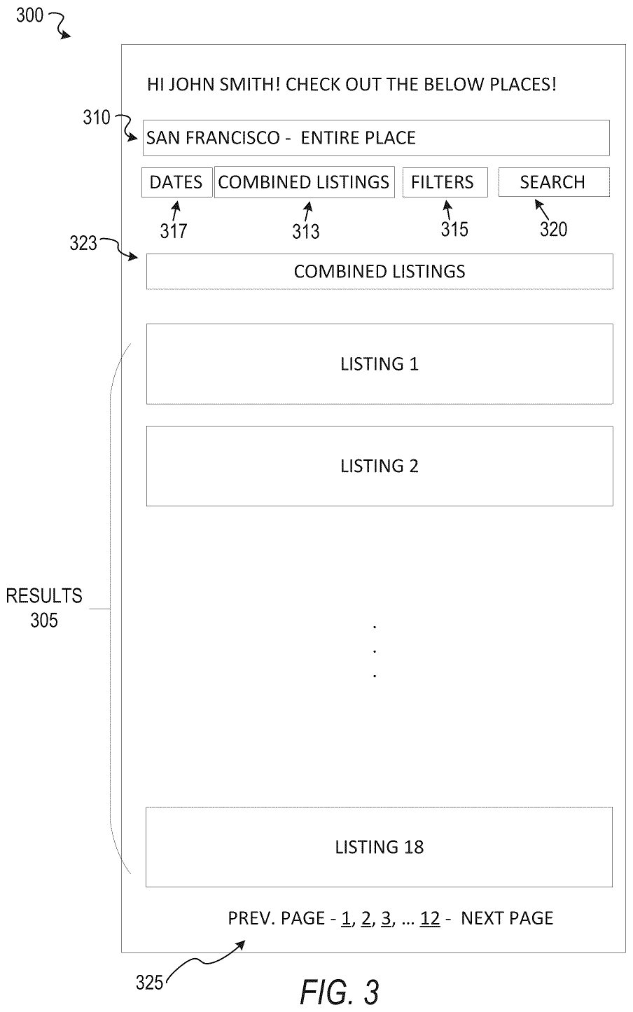

FIG. 3 shows a listings network site user interface 300 (e.g., mobile application user interface, web browser user interface) generated by the listing network platform 142 and listing search system 150, according to some examples. The user interface 300 can be presented by the programmatic client 116 implemented on the client device 110. As illustrated, the user interface 300 includes a search field 310, a filters menu element 315 (e.g., place type, amenities), and a search button 320. The user enters a listings query into the search field 310, such as a search for temporary housing in San Francisco, and a category limitation from the filters menu element 315 of “Entire Place” (e.g., the user seeks to rent the entire residence for said dates, as opposed to renting a private room in another person's residence). The user can customize the query directly using terms input into the search field 310 or filters listed via selection of the filters menu element 315. Further, the user can select dates using a dates drop-down element 317 to select a specific date range for the temporary stay. For example, the user can select the dates drop-down element 317 and a pop-up calendar (not depicted in FIG. 3) to specify the stay in San Francisco is to be specifically from Jul. 16, 2021 to Jul. 18, 2021. In some cases, the user can provide one or more attributes of the search query using the filters menu element 315, such as specifying ages of children and minimum/maximum duration of stay.

Upon submitting the query (e.g., via selection of the search button 320, or automatically upon selecting a combined listings element 313 (split stays option) or dates drop-down element 317), a communication is sent from the programmatic client 116 to the listing search system 150. The listing search system 150 generates an output that includes a results display of the listings (e.g., graphical objects) matching the query and transmits the output to the programmatic client 116.

The results are then displayed in a listings results area 305 using respective graphical objects (also referred to as indicators of listings). The user can then select the graphical objects for the listings or navigate to additional pages via page navigational elements 325. In some examples, the user interface 300 includes a set of combined listings 323 together with individual listings displayed in the results area 305. The combined listings 323 can be positioned within the display in a dedicated area, on top of the individual listings, between two individual listings, and/or underneath the individual listings. In some examples, the combined listings 323 are provided in response to receiving input that selects the combined listings element 313. In some examples, the combined listings 323 are presented automatically without receiving input that selects the combined listings element 313.

In some examples, the combined listings 323 are displayed in different slots or portions of the display relative to other individual listings on the basis of the type of client device being used to access the system. For example, on a mobile device, the combined listings 323 can be placed in slots 3, 6, 9, and 12 on the first page, and on a desktop computer, the same combined listings 323 may be presented in slots 5, 9, 14, and 20 for better visual balance. As referred to herein, the term “slots” means an area of a display in which a category is presented. In some cases, the combined listings 323 are excluded from being presented for last minute stays, such as if the travel dates are within 48 hours of check in or starting the trip. In some examples, the combined listings 323 include individual listings of destinations or stays that are at least two hours driving distance apart but no more than 10 hours driving distance apart. In some examples, the combined listings 323 exclude repeating pairs of the same individual listings. In some examples, the combined listings 323 relate to pairs of individual listings from different neighborhoods and locations. In such cases, neighborhoods and listings can be repeated across pairs of combined listings 323.

Using a specific example, a listing request can be received for a one-month stay in Kauai specifying beachfront homes. In this example, the user identifies only three individual listings that meet these search parameters but identifies ten additional stays as combined listings 323. The combined listings 323 can represent opportunities to experience different sides of the island throughout the trip and can include an option to split time between two cities (e.g., Koloa and Hanalei), split time between two other cities (e.g., Koloa and Lihue), split time between two listings that are 1 mile apart in Koloa, split time in related cites (e.g., Poipu and Princeville) and/or other related cities (e.g., Lihue and Princeville), and so forth. The result of selecting the combined listings element 313 or the user automatically identifying combined listings without having a combined listings element 313 can provide 40% more unique inventory for the user to select that would be excluded if only individual listings were presented.

In some examples, the combined listings 323 presentation can vary based on the type of category selected. For example, if a national parks category is selected, the combined listings 323 can include two different national park points of interest that are at least two hours' drive apart and a maximum of 10 hours' drive apart. In some cases, if the national parks are very remote, they can still be paired even if their distances exceed these thresholds. The combined listings 323 graphical representation can visually identify the two national park listings that form part of the same combined listing without specifying the region/city name. As another example, if a surfing category is selected, two different surfing destinations can be selected that are two hours' drive apart and a maximum of 10 hours' drive apart. The combined listings 323 graphical representation can visually identify the two surfing destinations that form part of the same combined listing using the region/city name.

The listing tour GUI component 260 can instruct the user interface 300 to present images for a certain listing that is selected from the results area 305. The images can be presented in a grouped manner. For example, a first image or first collection of images associated with a first classification can be presented in a first region of the GUI that is dedicated to presenting information/images for the first classification. A second image or second collection of images associated with a second classification can be presented in a second region of the GUI that is dedicated to presenting information/images for the second classification. The different regions with the different collections of images can be presented simultaneously in the same GUI.

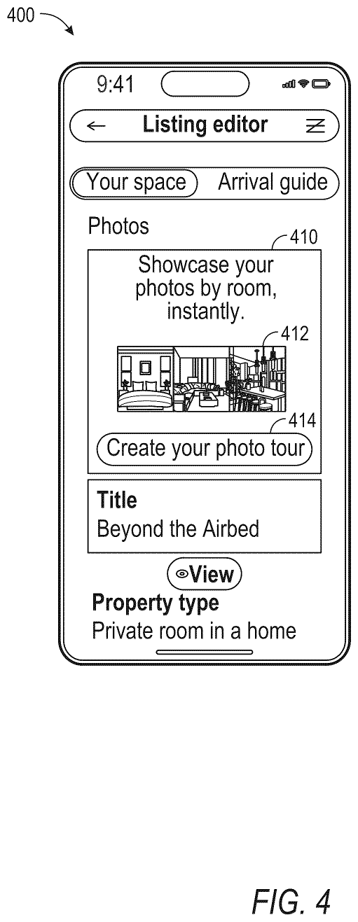

Referring back to the FIG. 2, the listing tour GUI component 260 allows a host to generate or define the classifications that are provided in a listing tour to end users in an automated or semi-automated manner. For example, the listing tour GUI component 260 presents a GUI, such as the example GUI 400 shown in FIG. 4. Specifically, the GUI 400 is accessed in response to receiving input from the user requesting to edit or modify a listing for a reservation. Among a plurality of fields of the listing that can be modified, the GUI 400 includes a photos editor field (or region) to allow the host to modify the arrangement of images associated with the listing and/or add new images.

The GUI 400 includes a graphical element 410 (e.g., a card) in the photos editor field. The graphical element 410 includes an information panel that explains the ability for the host to instantly and automatically generate classifications for previously uploaded images. The listing tour GUI component 260 accesses a list of previously uploaded images. The listing tour GUI component 260 identifies an order associated with each of the uploaded images. The order indicates the order in which the images are presented in a GUI to an end user who is searching or accessing the listing. The listing tour GUI component 260 can select a subset of images that are at the top of the order, such as the first three images in the sequence or order of images. The listing tour GUI component 260 can generate thumbnails for the first three images and present those thumbnails 412 as part of the graphical element 410.

In some examples, the listing tour GUI component 260 accesses classifications associated with the previously uploaded images, as discussed above. In some cases, the listing tour GUI component 260 accesses the groups of similar images that are generated by the second machine learning model based on embeddings and/or directly accesses the classifications generated by the first machine learning model. The listing tour GUI component 260 selects a first image associated with a first classification (group or cluster), a second image associated with a second classification (group or cluster), a third image associated with a third classification (group or cluster), and/or any number of additional images up to a specified threshold. The listing tour GUI component 260 generates thumbnails for the first, second, and third images and presents those thumbnails 412 as part of the graphical element 410.

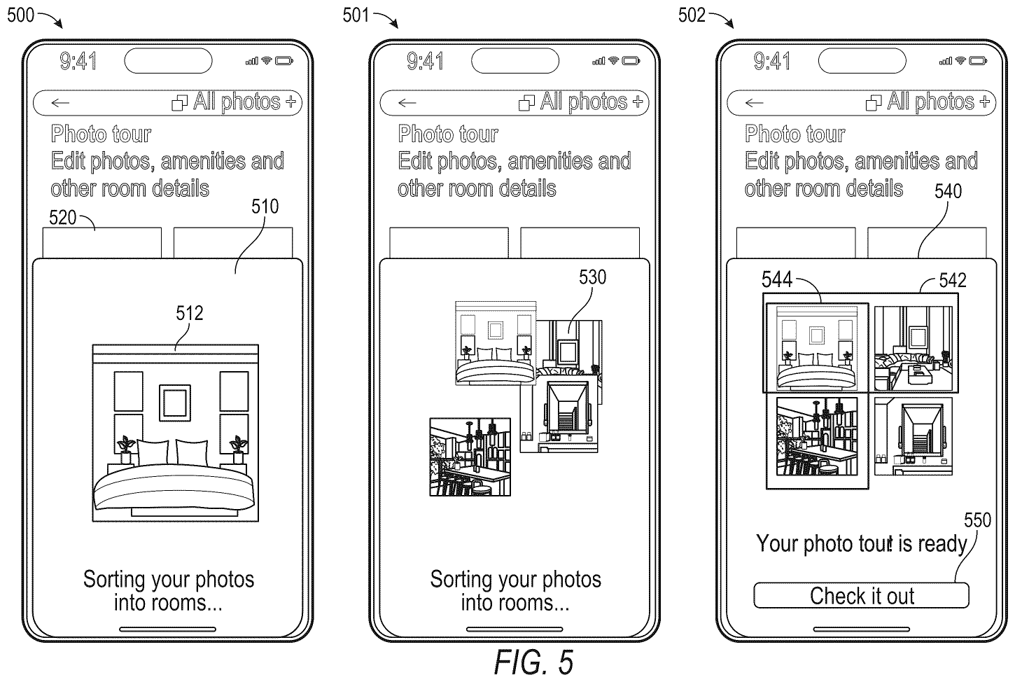

In some examples, the listing tour GUI component 260 presents an option 414 to trigger generation of a photo tour based on classifications associated with the previously uploaded images. In response to receiving input that selects the option 414, the listing tour GUI component 260 presents a sequence of user interfaces, such as example user interfaces 500, 501, and 502 shown in FIG. 5. This sequence of user interfaces 500, 501, and 502 indicates progress to the user in classifying the previously uploaded images into respective classifications or categories for generating the photo tour.

For example, a first user interface 500 can be presented that includes a graphical card 510. The graphical card 510 includes the same or different collection of images 512 that were presented in the graphical element 410 as thumbnails 412. The graphical card 510 includes a message indicating that the previously uploaded images are being sorted into respective classifications (or rooms or spaces). In some examples, the listing tour GUI component 260 retrieves a photo tour template. The photo tour template includes dedicated regions organized according to specified criteria. Each region is associated with and represents a different classification, room, or space. Each region includes an identifier of the corresponding classification. Before the images finish being classified (or before the visual animation/simulation of the classification completes, where the images have already been classified and clustered by the first and second machine learning models before input was received to generate the photo tour), the photo tour template includes placeholders (e.g., gray boxes) in each of the different regions. This photo tour template with the placeholders can be presented in the background 520 together with the graphical card 510. In some cases, as each image is classified, corresponding regions of the photo tour template are populated with the image that is classified.

In some cases, the same or different collection of images 512 are animated for a threshold period of time (e.g., 5 or 10 seconds) to represent to the user progress in classifying the images and associating the images with regions of the template. For example, as shown in a second user interface 501, a first animation 530 is presented in which the same or different collection of images 512 are scattered randomly in different directions. Then, a third user interface 502 is presented after the second user interface 501. In the sequence of user interfaces 502, the images that have been scattered randomly in different directions are randomly placed in a grid 540 (e.g., a four-by-four grid) where a single image is presented in each quadrant of the grid. During a first time interval, first and second images presented along a first dimension 542 (e.g., a first row) of the grid 540 are swapped so that a position of the first image takes the position of the second image and the position of the second image takes the position of the first image. This is represented with an animation showing the first image sliding towards the position of the second image followed by the position of the second image sliding towards the position of the first image.

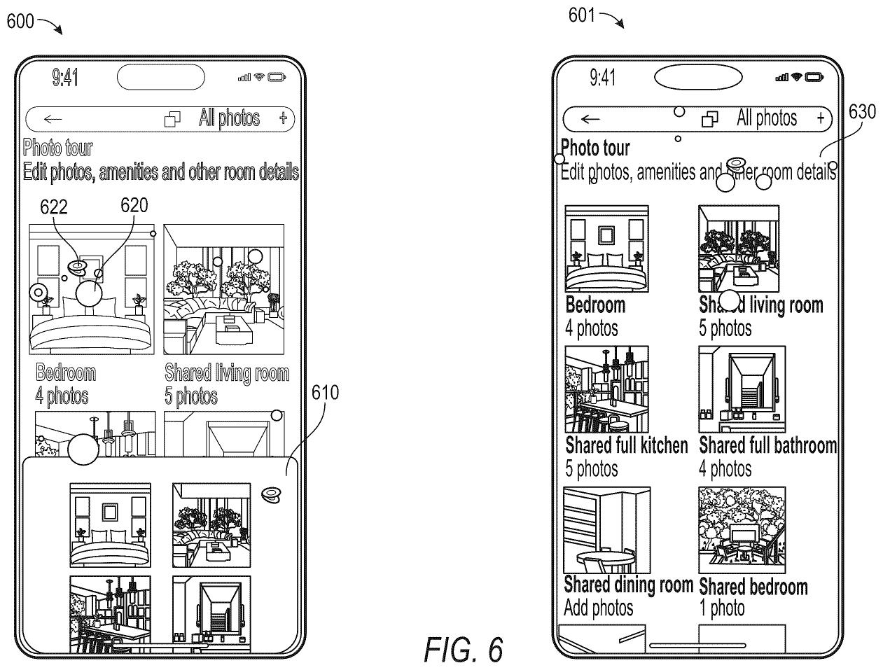

During a second time interval, the second image and a third image presented along a second dimension 544 (e.g., a first column) of the grid 540 are swapped so that a position of the second image takes the position of the third image and the position of the third image takes the position of the second image. This is represented with an animation showing the second image sliding towards the position of the third image followed by the position of the third image sliding towards the position of the second image. The process of swapping images along the first dimension 542 and the second dimension 544 in alternating manners is repeated for a threshold period of time (e.g., five seconds). After the threshold period of time elapses, the listing tour GUI component 260 presents an option 550 to access a preview of the photo tour. The listing tour GUI component 260 receives input that selects the option 550 and, in response, navigates the user to a sequence of user interfaces, such as example user interfaces 600 and 601 shown in FIG. 6.

Specifically, in response to receiving input that selects the option 550, the listing tour GUI component 260 animates a card 610 showing the grid 540 as sliding down the screen while presenting a celebration animation. The celebration animation can include many different types of graphical elements, such as confetti 620, balloons, and/or a logo 622 of the listing site falling sliding down the screen. The photo tour template continues to be presented in the background, such as in a dark contrast relative to the card 610 which is presented in a lighter contrast. Once the card 610 completely leaves the screen, the contrast of the photo tour template is increased while continuing to present the celebration animation. Specifically, as shown in the user interface 601, the photo tour template 630, which has now been populated with the images, is presented in a lighter contrast than the photo tour template shown in user interface 600. The sequence of user interfaces 601 also presents the celebration animation for a specified threshold period of time.

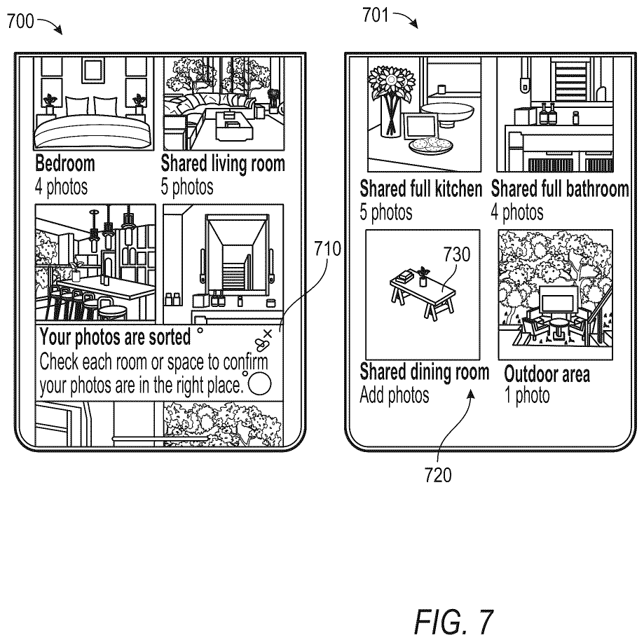

After the threshold period of time elapses, the listing tour GUI component 260 presents a sequence of user interfaces, such as example user interfaces 700 and 701 shown in FIG. 7. The sequence of user interfaces 700 and 701 no longer includes the celebration animation. As shown in user interface 700, a plurality of regions associated with different classifications is presented. For example, a first region associated with a first classification (group or cluster) is presented in a top left corner. Along with the first region, a description of the first classification is presented (e.g., bedroom) and a quantity of images that are associated with the first classification. The first region includes a random or specified image of the set of images associated with the first classification. In response to receiving input that selects the first region or the specified image, all of the corresponding images in the set of images associated with the first classification are presented.

A second region associated with a second classification is presented in a top right corner next to the first region. Along with the second region, a description of the second classification is presented (e.g., shared living room) and a quantity of images that are associated with the second classification. The second region includes a random or specified image of the set of images associated with the second classification. In response to receiving input that selects the second region or the specified image, all of the corresponding images in the set of images associated with the second classification are presented.

In some cases, a prompt 710 is presented that instructs the user or host to review the classifications by browsing the photo tour template that has been populated. The listing tour GUI component 260 can receive input that navigates the photo tour template to show each of the regions and their corresponding assigned images and descriptions. The listing tour GUI component 260 can receive input that moves one image from one region to another region to change the classification associated with the image.

In some examples, the listing tour GUI component 260 determines that the photo tour template includes an individual classification 720 that is not associated with any of the images. Namely, the listing tour GUI component 260 compares the classifications associated with all of the images and determines that none of the classifications match the individual classification 720. In this case, the listing tour GUI component 260 includes an individual region corresponding to the individual classification 720 for display together with the other regions in the photo tour template. The listing tour GUI component 260 can search a database of 3D or 2D graphical elements to find or identify a 3D or 2D graphical element that corresponds to the individual classification 720. The database can associate each 3D or 2D graphical element with a corresponding classification. Each 2D or 3D graphical element includes visual attributes that represent the corresponding classification. The listing tour GUI component 260 retrieves the 3D or 2D graphical element from the database that is associated with the individual classification 720 and presents that retrieved 3D or 2D graphical element 730 as part of the individual region of the photo tour template. The listing tour GUI component 260 can receive input that selects the 3D or 2D graphical element 730. In response, the listing tour GUI component 260 allows a user to submit or upload a new image or photo that corresponds to the individual classification 720 to replace the display of the 3D or 2D graphical element 730 in the individual region. In this way, the listing tour GUI component 260 can identify certain key rooms that are empty in that there does not exist a corresponding image or photo for that key room or classification. Based on this identification, the listing tour GUI component 260 can recommend to the user (host) to submit or upload or add additional images that correspond to the key room or classification. This helps build a complete loop between the photo tour completion and the phot tour's publication for guest users to view.

The ordering of the regions in the photo tour template can be static and non-modifiable by the user. In some cases, the user can change the ordering or organization of the regions of the photo tour template. In some cases, only users with advanced status or subscriptions can be allowed to change the ordering or organization of the regions of the photo tour template. In some cases, the ordering for the regions of the photo tour template can be a living area, full kitchen, kitchenette, dining area, bedroom, full bathroom, half bathroom, office, dedicated workspace, backyard, patio, balcony, front yard, deck, porch, courtyard, garden, terrace, rooftop, laundry area, garage, gym, exterior, pool, hot tub, theme room, children's playroom, bowling alley, movie theater, art studio, music studio, workshop, photography studio, darkroom, wood shop, event space, library, game room, sunroom, and wine cellar. Some of these can be omitted in certain situations.

In some examples, after the images are classified and/or clustered, the classifications can further be refined based on amenities associated with the listing. In such cases, the listing tour GUI component 260 obtains a list of amenities associated with the individual listing and detects a physical space in an individual image of the plurality of images. For example, the listing tour GUI component 260 applies one or more trained machine learning models to extract features from the individual image and estimate an amenity or physical space featured in the individual image. The listing tour GUI component 260 selects an individual classification of the plurality of classifications based on the list of amenities associated with the individual listing and the detected physical space and associates the individual classification with the individual image. The listing tour GUI component 260 can determine that the list of amenities includes a first amenity and excludes a second amenity. The listing tour GUI component 260, in response to determining that the list of amenities includes the first amenity and excludes the second amenity, selects a first classification as the individual classification. The listing tour GUI component 260, in response to determining that the list of amenities excludes the first amenity and excludes the second amenity, selects a second classification as the individual classification.

For example, the listing tour GUI component 260 can assign images based on existing amenities specified in the listing. Specifically, the listing tour GUI component 260 detects an outdoor space (patio, balcony, backyard, porch, etc.) in an individual image. If the listing tour GUI component 260 determines that the listing has a backyard amenity and does not have patio/balcony amenity, the listing tour GUI component 260 assigns the image to backyard space (or classification). If the listing tour GUI component 260 determines that the listing has a patio/balcony amenity and does not have backyard amenity, the listing tour GUI component 260 assigns the image to a balcony classification if the listing corresponds to an apartment or condominium and assigns the image to a patio classification if the listing does not correspond to an apartment or condominium. If the listing tour GUI component 260 determines that the listing has both a backyard and a patio/balcony amenity, the listing tour GUI component 260 does not assign the image to any space or classification. The listing tour GUI component 260 can still create the backyard and patio rooms or classifications but may prevent assigning the image to those rooms or classifications. If the listing tour GUI component 260 determines that the listing excludes a backyard and patio/balcony amenities, the listing tour GUI component 260 assigns the image to an exterior space or classification.

As another example, if a pool is detected in the image, then the listing tour GUI component 260 determines whether the listing includes a pool amenity and excludes a backyard amenity. In such cases, the listing tour GUI component 260 assigns the image to the pool space or classification if the listing corresponds to an apartment or condominium and assigns the image to the backyard amenity if the listing does not correspond to an apartment or condominium.

In some examples, the listing tour GUI component 260 groups similar images together, such as by applying the second machine learning model to the classifications generated by the first machine learning model and/or by processing amenities or other attributes associated with a listing. Namely, if the listing specifies more than one bedroom/bathroom, the listing tour GUI component 260 can apply a second machine learning model to images and their classifications in order to generate clusters or groups of images. For example, the listing tour GUI component 260 can cluster images with the bedroom type classification with the full bathroom and half bathroom type classifications of images. If the listing has only one bedroom, the listing tour GUI component 260 assigns images with a bedroom to the bedroom classification, without applying the second machine learning model for generating clusters of images based on similarity. If the listing has only one bathroom, the listing tour GUI component 260 assigns images with a bathroom to the bathroom classification. If the listing includes multiple bedrooms/bathrooms, the listing tour GUI component 260 applies the second machine learning model to the image classifications to assign or group images to bedroom numbers in order of group size, largest to smallest based on their similarity scores corresponding to their embeddings. If the listing tour GUI component 260 determines that the listing does not include any bedrooms, the listing tour GUI component 260 creates a sleeping area object or classification and can associate any image that has a bedroom with the sleeping area object or classification.

For example, the listing tour GUI component 260 can conditionally apply the second machine learning model to classifications of images based on whether a listing includes multiple of the same type of amenity (e.g., if the listing includes multiple bedrooms). In such cases, the listing tour GUI component 260 can group a first cluster of similar images (having similar embeddings) with a first bedroom as determined by the second machine learning and can group a second cluster of similar images (having similar embeddings) with a second bedroom as determined by the second machine learning model embedding.

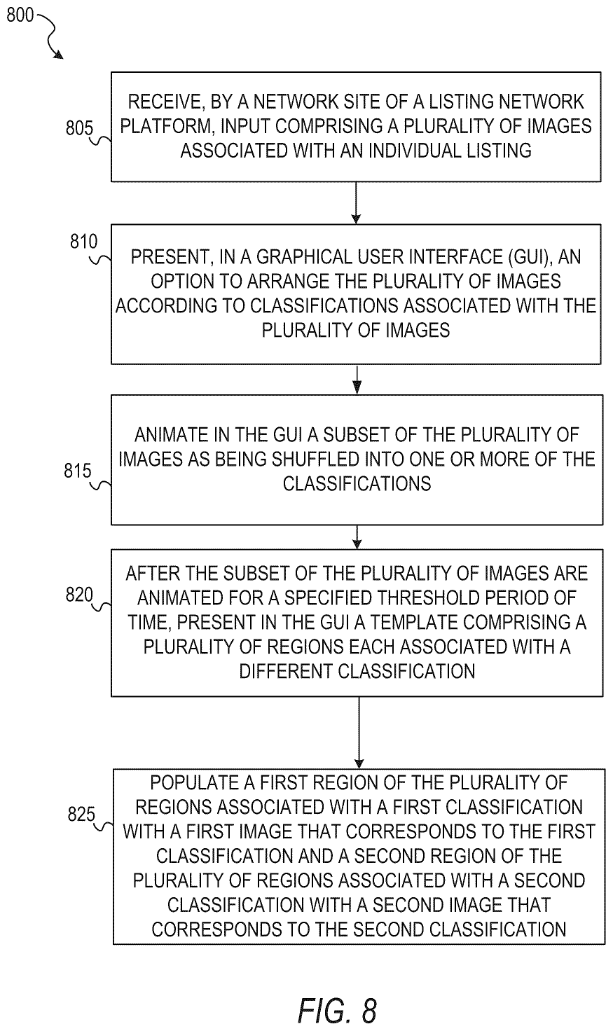

FIG. 8 shows a flow diagram of various processes and methods 800 for generating listings on a listing network site, according to some examples. These processes and methods 800 can be performed by any component discussed above or below, such as the listing search system 150, and in any order or sequence.

At operation 805, the listing search system 150 receives, by a network site of a listing network platform, input comprising a plurality of images associated with an individual listing, as discussed above.

At operation 810, the listing search system 150 presents, in a GUI, an option to arrange the plurality of images according to classifications associated with the plurality of images, as discussed above.

At operation 815, the listing search system 150, in response to receiving input that selects the option, animates in the GUI a subset of the plurality of images as being shuffled into one or more of the classifications, as discussed above.

At operation 820, after the subset of the plurality of images are animated for a specified threshold period of time, the listing search system 150 presents in the GUI a template comprising a plurality of regions each associated with a different classification, as discussed above.

At operation 825, the listing search system 150 populates a first region of the plurality of regions associated with a first classification with a first image that corresponds to the first classification and a second region of the plurality of regions associated with a second classification with a second image that corresponds to the second classification, as discussed above.

### EXAMPLES

Example 1. A method comprising: receiving, by a network site of a listing network platform, input comprising a plurality of images associated with an individual listing; presenting, in a graphical user interface (GUI), an option to arrange the plurality of images according to classifications associated with the plurality of images; in response to receiving input that selects the option, animating in the GUI a subset of the plurality of images as being shuffled into one or more of the classifications; after the subset of the plurality of images are animated for a specified threshold period of time, presenting in the GUI a template comprising a plurality of regions each associated with a different classification; and populating a first region of the plurality of regions associated with a first classification with a first image that corresponds to the first classification and a second region of the plurality of regions associated with a second classification with a second image that corresponds to the second classification.

Example 2. The method of Example 1, further comprising: analyzing the plurality of images by a machine learning model to determine respective classifications associated with each of the plurality of images.

Example 3. The method of Example 2, wherein the machine learning model analyzes the plurality of images in response to receiving the input that selects the option.

Example 4. The method of any one of Examples 2-3, wherein the machine learning model analyzes the plurality of images as each respective image of the plurality of images is received by the input and prior to presenting the option to arrange the plurality of images in the GUI.

Example 5. The method of Example 4, further comprising: receiving additional input comprising an additional image associated with the listing; and in response to receiving the additional input, re-analyzing the plurality of images that have previously been classified by the machine learning model together with the additional image to generate or update classifications for each of the plurality of images including the additional image.

Example 6. The method of any one of Examples 1-5, wherein the first classification comprises a first room type, and wherein the second classification comprises a second room type.

Example 7. The method of any one of Examples 1-6, further comprising: enabling a user to modify the classifications associated with the plurality of images by interacting with the template presented in the GUI.

Example 8. The method of any one of Examples 1-7, wherein an ordering in which the plurality of regions are presented in the GUI is predefined, the ordering comprising a living area, full kitchen, kitchenette, dining area, bedroom, full bathroom, half bathroom, office, dedicated workspace, backyard, patio, balcony, front yard, deck, porch, courtyard, garden, terrace, rooftop, laundry area, garage, gym, exterior, pool, hot tub, theme room, children's playroom, bowling alley, movie theater, art studio, music studio, workshop, photography studio, darkroom, wood shop, event space, library, game room, sunroom, and wine cellar.

Example 9. The method of any one of Examples 1-8, further comprising: selecting one or more images from the plurality of images based on one or more criteria; and presenting the one or more images that have been selected in a graphical element comprising the option to arrange the plurality of images according to classifications.

Example 10. The method of Example 9, wherein the one or more criteria comprise at least one of an order in which the images are presented in the listing or respective classifications of the images.

Example 11. The method of any one of Examples 9-10, wherein the subset of the plurality of images comprises the one or more images that have been selected, further comprising: presenting a graphical element that presents the animating of the subset of the plurality of images on top of the template, wherein each of the plurality of regions of the template comprises a placeholder for respective images.

Example 12. The method of Example 11, wherein the placeholder comprises a gray box.

Example 13. The method of any one of Examples 1-12, further comprising: presenting an animation comprising celebration graphics on top of the template that includes the first region with the first image and the second region with the second image.

Example 14. The method of Example 13, wherein the celebration graphics comprise at least one of confetti, balloons, or a logo associated with the network site.

Example 15. The method of any one of Examples 1-14, further comprising: determining that an individual classification of the plurality of classifications is unassigned to any of the plurality of images; identifying an individual region of the plurality of regions associated with the individual classification; and populating the individual region in the GUI with a three-dimensional graphical element that represents the individual classification in response to determining that the individual classification is unassigned to any of the plurality of images.

Example 16. The method of Example 15, further comprising: storing a database that associates a plurality of classifications with respective three-dimensional graphical elements representing the classifications; and retrieving, from the database, the three-dimensional graphical element by searching the database based on the individual classification.

Example 17. The method of any one of Examples 1-16, further comprising: obtaining a list of amenities associated with the individual listing; detecting a physical space in an individual image of the plurality of images; selecting an individual classification of the plurality of classifications based on the list of amenities associated with the individual listing and the detected physical space; and associating the individual classification with the individual image.

Example 18. The method of Example 17, further comprising: determining that the list of amenities includes a first amenity and excludes a second amenity; and in response to determining that the list of amenities includes the first amenity and excludes the second amenity, selecting a first classification as the individual classification; and in response to determining that the list of amenities excludes the first amenity and excludes the second amenity, selecting a second classification as the individual classification.

Example 19. A system comprising: one or more processors of a machine; and a memory storing instruction that, when executed by the one or more processors, cause the machine to perform operations comprising: receiving, by a network site of a listing network platform, input comprising a plurality of images associated with an individual listing; presenting, in a graphical user interface (GUI), an option to arrange the plurality of images according to classifications associated with the plurality of images; in response to receiving input that selects the option, animating in the GUI a subset of the plurality of images as being shuffled into one or more of the classifications; after the subset of the plurality of images are animated for a specified threshold period of time, presenting in the GUI a template comprising a plurality of regions each associated with a different classification; and populating a first region of the plurality of regions associated with a first classification with a first image that corresponds to the first classification and a second region of the plurality of regions associated with a second classification with a second image that corresponds to the second classification.

Example 20. A machine-readable storage device embodying instructions that, when executed by a machine, cause the machine to perform operations comprising: receiving, by a network site of a listing network platform, input comprising a plurality of images associated with an individual listing; presenting, in a graphical user interface (GUI), an option to arrange the plurality of images according to classifications associated with the plurality of images; in response to receiving input that selects the option, animating in the GUI a subset of the plurality of images as being shuffled into one or more of the classifications; after the subset of the plurality of images are animated for a specified threshold period of time, presenting in the GUI a template comprising a plurality of regions each associated with a different classification; and populating a first region of the plurality of regions associated with a first classification with a first image that corresponds to the first classification and a second region of the plurality of regions associated with a second classification with a second image that corresponds to the second classification.

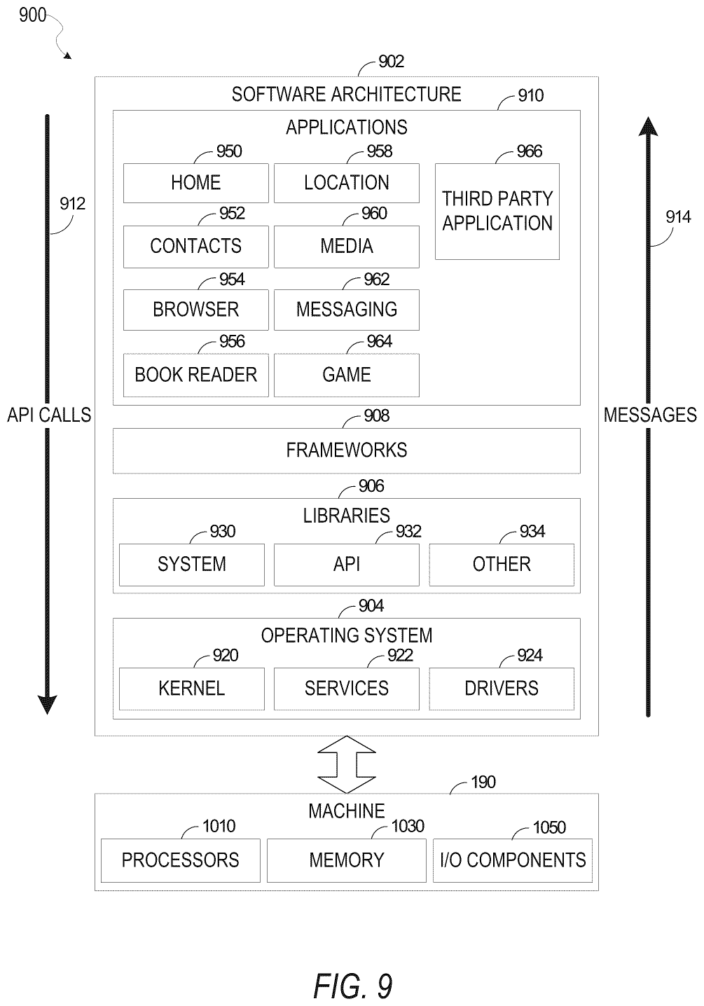

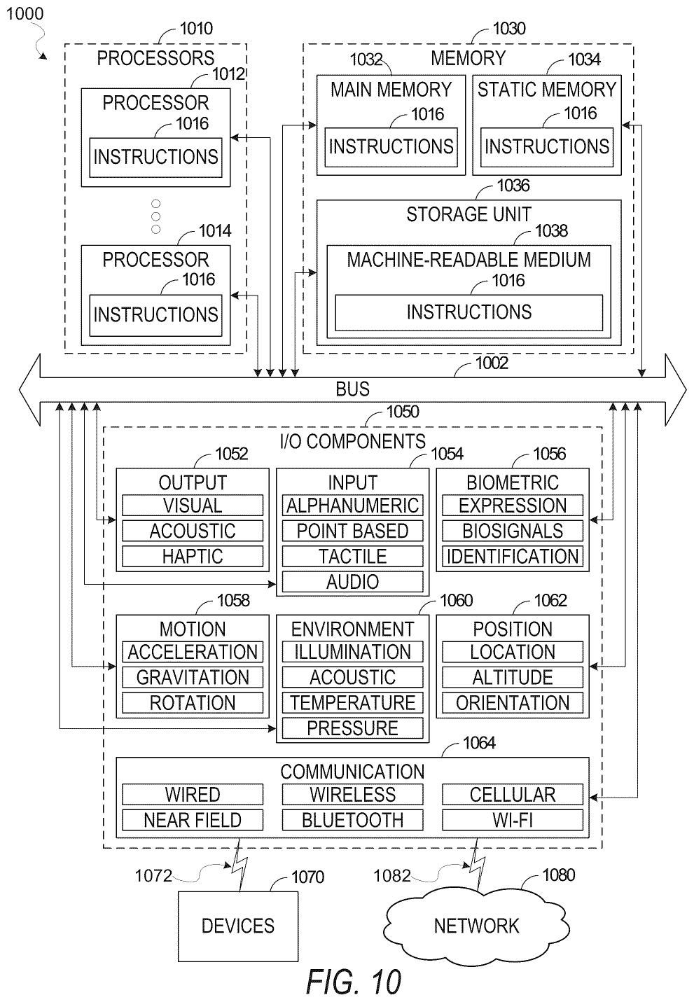

FIG. 9 is a block diagram 900 illustrating an architecture of software 902, which can be installed on any one or more of the devices described above. FIG. 9 is merely a non-limiting example of a software architecture, and it will be appreciated that many other architectures can be implemented to facilitate the functionality described herein. In various embodiments, the software 902 is implemented by hardware such as a machine 1000 of FIG. 10 that includes processors 1010, memory 1030, and input/output (I/O) components 1050. In this example architecture, the software 902 can be conceptualized as a stack of layers where each layer may provide a particular functionality. For example, the software 902 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and 3D in a graphic content on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphic user interface (GUI) functions, high-level resource management, high-level location services, and so forth. The frameworks 908 can provide a broad spectrum of other APIs that can be utilized by the applications 910, some of which may be specific to a particular operating system or platform.

In an example embodiment, the applications 910 include a home application 950, a contacts application 952, a browser application 954, a book reader application 956, a location application 958, a media application 960, a messaging application 962, a game application 964, and a broad assortment of other applications such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate the functionality described herein.

FIG. 10 illustrates a diagrammatic representation of a machine 1000 in the form of a computer system within which a set of instructions may be executed for causing the machine to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, an STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory 1030 may include a main memory 1032, a static memory 1034, and a storage unit 1036, all accessible to the processors 1010 such as via the bus 1002. The main memory 1032, the static memory 1034, and storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

The various memories (i.e., 1030, 1032, 1034, and/or memory of the processor(s) 1010) and/or storage unit 1036 may store one or more sets of instructions and data structures (e.g., software) embodying or utilized by any one or more of the methodologies or functions described herein. These instructions (e.g., the instructions 1016), when executed by processor(s) 1010, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a VPN, an LAN, a WLAN, a WAN, a WWAN, an MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A method comprising:
receiving, by a network site of a listing network platform, input comprising a plurality of images associated with an individual listing;
presenting, in a graphical user interface (GUI), an option to arrange the plurality of images according to classifications associated with the plurality of images;
in response to receiving input that selects the option, animating in the GUI a subset of the plurality of images as being shuffled into one or more of the classifications;
after the subset of the plurality of images are animated for a specified threshold period of time, presenting in the GUI a template comprising a plurality of regions each associated with a different classification; and
populating a first region of the plurality of regions associated with a first classification with a first image that corresponds to the first classification and a second region of the plurality of regions associated with a second classification with a second image that corresponds to the second classification.

2. The method of claim 1, further comprising:
analyzing the plurality of images by a machine learning model to determine respective classifications associated with each of the plurality of images.

3. The method of claim 2, wherein the machine learning model analyzes the plurality of images in response to receiving the input that selects the option.

4. The method of claim 2, wherein the machine learning model analyzes the plurality of images as each respective image of the plurality of images is received by the input and prior to presenting the option to arrange the plurality of images in the GUI.

5. The method of claim 4, further comprising:
receiving additional input comprising an additional image associated with the listing; and in response to receiving the additional input, re-analyzing the plurality of images that have previously been classified by the machine learning model together with the additional image to generate or update classifications for each of the plurality of images including the additional image.

6. The method of claim 1, wherein the first classification comprises a first room type; and
wherein the second classification comprises a second room type.

7. The method of claim 1, further comprising:
enabling a user to modify the classifications associated with the plurality of images by interacting with the template presented in the GUI.

8. The method of claim 1, wherein an ordering in which the plurality of regions are presented in the GUI is predefined, the ordering comprising a living area, full kitchen, kitchenette, dining area, bedroom, full bathroom, half bathroom, office, dedicated workspace, backyard, patio, balcony, front yard, deck, porch, courtyard, garden, terrace, rooftop, laundry area, garage, gym, exterior, pool, hot tub, theme room, children's playroom, bowling alley, movie theater, art studio, music studio, workshop, photography studio, darkroom, wood shop, event space, library, game room, sunroom, and wine cellar.

9. The method of claim 1, further comprising:
selecting one or more images from the plurality of images based on one or more criteria; and presenting the one or more images that have been selected in a graphical element comprising the option to arrange the plurality of images according to classifications.

10. The method of claim 9, wherein the one or more criteria comprise at least one of an order in which the images are presented in the listing or respective classifications of the images.

11. The method of claim 9, wherein the subset of the plurality of images comprises the one or more images that have been selected, further comprising: presenting a graphical element that presents the animating of the subset of the plurality of images on top of the template, wherein each of the plurality of regions of the template comprises a placeholder for respective images.

12. The method of claim 11, wherein the placeholder comprises a gray box.

13. The method of claim 1, further comprising:
presenting an animation comprising celebration graphics on top of the template that includes the first region with the first image and the second region with the second image.

14. The method of claim 13, wherein the celebration graphics comprise at least one of confetti, balloons, or a logo associated with the network site.

15. The method of claim 1, further comprising:
determining that an individual classification of the plurality of classifications is unassigned to any of the plurality of images; and
identifying an individual region of the plurality of regions associated with the individual classification; and populating the individual region in the GUI with a three-dimensional graphical element that represents the individual classification in response to determining that the individual classification is unassigned to any of the plurality of images.

16. The method of claim 15, further comprising:
storing a database that associates a plurality of classifications with respective three-dimensional graphical elements representing the classifications; and retrieving, from the database, the three-dimensional graphical element by searching the database based on the individual classification.

17. The method of claim 1, further comprising:
obtaining a list of amenities associated with the individual listing; detecting a physical space in an individual image of the plurality of images; and
selecting an individual classification of the plurality of classifications based on the list of amenities associated with the individual listing and the detected physical space; and associating the individual classification with the individual image.

18. The method of claim 17, further comprising:
determining that the list of amenities includes a first amenity and excludes a second amenity;
in response to determining that the list of amenities includes the first amenity and excludes the second amenity, selecting a first classification as the individual classification; and
in response to determining that the list of amenities excludes the first amenity and excludes the second amenity, selecting a second classification as the individual classification.

19. A system comprising:
one or more processors of a machine; and
a memory storing instruction that, when executed by the one or more processors, cause the machine to perform operations comprising:
receiving, by a network site of a listing network platform, input comprising a plurality of images associated with an individual listing;
presenting, in a graphical user interface (GUI), an option to arrange the plurality of images according to classifications associated with the plurality of images;
in response to receiving input that selects the option, animating in the GUI a subset of the plurality of images as being shuffled into one or more of the classifications;
after the subset of the plurality of images are animated for a specified threshold period of time, presenting in the GUI a template comprising a plurality of regions each associated with a different classification; and
populating a first region of the plurality of regions associated with a first classification with a first image that corresponds to the first classification and a second region of the plurality of regions associated with a second classification with a second image that corresponds to the second classification.

20. A machine-readable storage device embodying instructions that, when executed by a machine, cause the machine to perform operations comprising:
receiving, by a network site of a listing network platform, input comprising a plurality of images associated with an individual listing;
presenting, in a graphical user interface (GUI), an option to arrange the plurality of images according to classifications associated with the plurality of images;
in response to receiving input that selects the option, animating in the GUI a subset of the plurality of images as being shuffled into one or more of the classifications;
after the subset of the plurality of images are animated for a specified threshold period of time, presenting in the GUI a template comprising a plurality of regions each associated with a different classification; and
populating a first region of the plurality of regions associated with a first classification with a first image that corresponds to the first classification and a second region of the plurality of regions associated with a second classification with a second image that corresponds to the second classification.
